(19) United States
(12) Patent Application Publication
(10) Pub. No.: US 2021/0027302 A1
(43) Pub. Date: Jan. 28, 2021

(54) DETECTING LIFE EVENTS BY APPLYING ANOMALY DETECTION METHODS TO TRANSACTION DATA

(71) Applicant: Intuit Inc., Mountain View, CA (US)

(72) Inventors: Yehezkel S. Resheff, Tel Aviv (IL); Yair Horesh, Kfar-Saba (IL); Shimon Shahar, Rishon-Letziyon (IL); Daniel Ben-David, Mesilat Zion (IL)

(73) Assignee: Intuit Inc., Mountain View, CA (US)

(21) Appl. No.: 16/521,814

(22) Filed: Jul. 25, 2019

(51) Int. Cl. G06Q 20/40; G06N 20/00; H04L 29/08

(52) U.S. Cl. CPC G06Q 20/4093; H04L 67/22; G06N 20/00

(57) ABSTRACT

Machine learning-based anomaly detection methods are used to identify a change in a user's streaming transaction data. If a threshold level of change in the user's transaction data is detected, the user is then identified as potentially having experienced a life event. Then, after a user is identified has having potentially experienced a life event, individual user transactions are processed and analyzed to determine the specific life event the user has most likely experienced. The user is then identified as having experienced the identified specific life event. This information is then used to customize the interactions between the user and the data management system such as questions asked of the user, forms or displays provided to the user, or offers made to the user.

### BACKGROUND

Data management systems, such as tax preparation systems, small business management systems, transaction management systems, and personal financial management systems have proven to be valuable and popular tools for helping users of these systems perform various tasks and manage their personal and professional lives. Ideally, the services provided to users of a data management system should include providing users with analysis and support that is customized to the individual user. To this end, data management systems should be able to recognize changes in user status and adjust the user's experience to accommodate these changes. For instance, when a user experiences a “life event,” such as moving, a new job, marriage, a new child, purchasing a house or apartment, retiring, and the like, the data management system should customize the user's experience and interactions with the data management system accordingly.

When a user experiences one or more of these life events, there is often a significant ripple effect on the user's financial and personal status that can have significant ramifications with respect to services provided, or that should be provided, to the user by data management systems. However, users experiencing life events often fail to inform the data management system of the occurrence of the life events, or even realize the full effect and ramifications associated with the life events. Consequently, it is desirable that life events be detected by the data management systems themselves so the data management systems can adapt and customize the services provided to the user based on the occurrence of the detected life events.

As a specific illustrative example, when the data management system is a tax preparation system it is highly desirable that the tax preparation system help the user identify relevant life events the user may have experienced, and the potential tax ramifications associated with those events. This is particularly important since most users only interact with a tax preparation system yearly. Consequently, life events taking place in the previous year may easily be overlooked or forgotten by the user at tax time. For instance, if a customer moves, there may be tax deductions or other tax ramifications associated with the move. Similarly, marriage or the birth of a child can also have significant tax ramifications, as can a change in employment or career. Consequently, it would benefit the user of a tax preparation system significantly if these life events were accurately and automatically detected.

In addition, if the tax preparation system were able to accurately and automatically determine the occurrence of a life event, the tax preparation system could also provide a user with a customized user experience based on the identified life event. This could include modifying the sequencing of tax related questions when preparing the user's tax forms, providing the user with life event related forms or attachments, or making the user aware of features and products related to life event.

Accurately and automatically identifying the occurrence of life events is a valuable and highly desirable feature for data management systems other than tax preparation systems as well. For instance, business management systems, personal financial management systems, and transaction management systems could better serve users of these systems if the occurrence of life events could be accurately and efficiently detected automatically. For instance, the occurrence of a life event could significantly change the analysis performed by data management systems, and recommendations made to the user, associated with budgeting, inventory management, retirement planning, etc.

While it is widely recognized that automatically and accurately identifying when a user of a data management system has been subject to a life event is an important feature, an efficient and effective solution to the technical problem of automatically and accurately detecting when a life event has occurred has proven elusive. One reason for the current lack of an efficient and effective solution is that, historically, life event detection has been approached using anecdotal methods. These traditional anecdotal methods are based on identifying individual user transactions, typically in relative in isolation, that have been pre-determined to be indicative of a life event.

For instance, using traditional methods, data representing a user's individual transactions are each analyzed to identify any changes in transactions with merchants, in purchase categories, or at locations, that have been pre-determined to be indicative of a life event. While these traditional anecdotal approaches do have some value, they can also result is an often-unacceptable number of false positives, and negatives, and require significant human and non-human resources. This is because, using traditional approaches, the individual transactions associated with a user are typically processed in isolation before a life event is even suspected. In attempts to decrease the number of false positive and negative results, many traditional approaches require a user profile that must be created based on even more analysis and processing of the user's historical transactions.

As a specific illustrative example, using traditional methods, if in the course of analyzing each of a user's transactions a threshold number of transactions having locations outside the user's “normal” locations are identified, this would be considered indicative of a potential user move. However, using traditional methods, in order to identify the potential move, not only must each of the user's individual transactions be analyzed, but a user profile of historical user locations must first be generated to establish the user's normal locations before any deviation from these normal locations can be recognized. Consequently, using traditional methods, the user's historical transactions must first be processed to generate a profile for the user including normal locations associated with the user's transactions. Then each new user transaction must be processed and compared with the user's profile to detect any deviations from the normal locations associated with the user's transactions represented in the user's profile.

To further complicate the situation, using traditional methods, different data elements, or portions, of the user's profile and data elements of the each of the new user transactions must be processed and compared for each different life event. For instance, while location data is used to identify a potential user move, merchant payee data, or items purchased description data is used to identify other life events such as marriage or the birth of a child. Since using traditional methods this analysis is performed for each user transaction, and often before the occurrence of a life event is even indicated, these traditional methods are extremely inefficient and expensive in terms of human and non-human resources.

In addition, even after the expense of traditional methods is incurred, traditional methods are still often ineffective because of the large number of false positive and negative results. The large number of false positive and negative results are a by-product of the fact that using traditional methods analysis is typically performed on each new user transaction before the occurrence of a life event is even indicated. This not only adds to the expense of the analysis, but it also results in analysis at too granular a level too early in the process, i.e., before there is any actual indication of the occurrence of a life event. This, in turn, often results in false identification of a life event based on too little data as individual transactions, including outlier transactions, can have a disproportionate influence on the life event identification process.

As discussed above, traditional life event detection methods are inefficient and ineffective because they are expensive to implement and often produce inaccurate results. What is needed is a technical solution to the technical problem of efficiently and accurately identifying when a user of a data management system has been subject to a life event or other change in status.

### SUMMARY

The systems and methods of the present disclosure provide a technical solution to the technical problem of efficiently and accurately detecting when a user of a data management system has been subject to a life event or change in status. This is accomplished by applying machine learning-based anomaly detection methods systematically to the continuous and dynamic stream of the user's transaction data to identify a change, or anomaly, in the user's transaction activity without initially analyzing individual user transactions. Using the disclosed embodiments, if a threshold change in the stream of a user's transaction activity is detected, the user is then identified as potentially having experienced some type of life event. Using the disclosed embodiments, and in contrast to traditional methods, only after a user is identified has having potentially experienced some type of life event is the detected anomaly and associated transaction data analyzed at the individual transaction level to determine the specific type of life event the user has experienced.

In one example, once a user is identified has having potentially experienced a life event by virtue of a detected anomaly, the user's transaction data is analyzed by humans to determine if the user has indeed experienced an associated life event and what type of specific life event the user has experienced. The user is then identified, or tagged, as having experienced the specific life event.

In one example, once enough user anomalies have been detected, and the associated user transaction data is analyzed to determine what type of life event the user has experienced, data representing these correlated pairs of detected anomalous user transaction data and identified specific life event data can be used as training data for one or machine learning-based life event identification models. Once the one or more machine learning-based life event identification models are trained, future detected anomalous data associated with users of the data management system can be processed by the trained machine learning-based life event identification models and probabilistically associated with specific life events. If a determination is made that the probability that a user has experienced an associated life event is greater than a threshold value, the user is then identified, or tagged, as having experienced the associated life event without the need of additional human analysis beyond creating the training data.

Once a user is identified as having experienced a specific life event, either by human analysis or a trained machine learning-based life event identification model, this information is provided to the data management system and used to customize the interactions between the user and the data management system based on the identified specific life event.

In contrast to traditional methods, using the disclosed embodiments, life event detection is initially performed using systematic methods based on identifying anomalies in a continuous stream of the user's transaction/purchase activity. This is in direct contrast to traditional methods of analyzing individual user transactions in isolation and comparing the individual transactions with transaction types and changes pre-determined to be indicative of a specific life event.

In contrast to traditional methods, the disclosed embodiments represent a more efficient and holistic approach with the initial anomaly detection stage serving as a gating function before more significant individual transaction analysis is performed. Since most users' transaction data will not have a threshold level of anomaly, i.e., most users will not have experienced a life event in a given time frame, the disclosed embodiments represent a far more efficient system in terms of processing costs. In addition, since individual transactions are only processed after a user life event is detected using anomaly detection methods, the disclosed embodiments are subject to fewer false positives and negatives, i.e., provide more accurate predictions and results.

Using the disclosed embodiments, analysis of individual transaction data, and the creation and comparisons with user profiles, is eliminated for the vast majority of users. As a result, implementation of the disclosed embodiments results in less processing power utilization, less memory usage, and less bandwidth usage. It follows that data management systems and computing systems implementing the disclosed embodiments will be more efficient and effective than those using traditional methods of life event detection.

As a result of these and other disclosed features discussed in more detail below, the disclosed embodiments provide an extremely efficient, effective, and flexible technical solution the long standing technical problem of automatically, efficiently, and accurately identifying when a user of a data management system has been subject to a life event or change in status.

### BRIEF DESCRIPTION OF THE DRAWINGS

FIG. 1 is a high-level block diagram of a production environment for implementing a system for detecting life events by applying anomaly detection methods to transaction data in accordance with one embodiment.

FIG. 2 is an illustrative example of raw user transaction data received by a data management system.

FIG. 3 is a block diagram of a life event detection module included in a system for detecting life events by applying anomaly detection methods to transaction data in accordance with one embodiment.

FIG. 4 is a block diagram of an anomaly detection module included in a life event detection module of FIG. 3 in accordance with one embodiment.

FIG. 5A is an illustrative example of structured user transaction data generated by processing the raw user transaction data of FIG. 2 to identify and isolate anomaly detection elements.

FIG. 5B is a table of multiple structured user transactions, such as those depicted in FIG. 5A, obtained from a stream of transactions associated with a specific illustrative user for anomaly detection by an anomaly detection module in accordance with one embodiment.

FIG. 6A is a high-level diagram of the table of multiple structured user transactions of FIG. 5B being used by the anomaly detection module of FIG. 4 to generate base/v1 vector data associated with a specific illustrative user in accordance with one embodiment.

FIG. 6B shows a table of multiple structured user transactions obtained from a stream of transactions associated with the specific illustrative user including transaction data representing new transactions obtained after the base/v1 vector data associated with the specific illustrative user of FIG. 6A has been generated in accordance with one embodiment.

FIG. 7 is a high-level diagram of a comparison window, or selected comparison analysis portion, of the table of multiple structured user transactions associated with a specific illustrative user of FIG. 6B used by the anomaly detection module of FIG. 4 to generate comparison/v2 vector data associated with the specific illustrative user in accordance with one embodiment.

FIG. 8 is a high-level diagram of a life event prediction module, including one or more trained machine learning-based life event identification models, implemented in the life event detection module of FIG. 3 in accordance with one embodiment.

FIG. 9 shows an illustrative example of life event probability data generated by the one or more trained machine learning-based life event identification models of the life event prediction module of FIG. 8 in accordance with one embodiment.

FIG. 10 is a high-level diagram of an optional validation transaction identification module included in a life event detection module of FIG. 3 in accordance with one embodiment.

FIG. 11 is a flow chart of a process for detecting life events by applying anomaly detection methods to transaction data in accordance with one embodiment.

FIG. 12 is a flow chart of a process for detecting life events by applying anomaly detection methods to transaction data including the training and use of a machine learning-based model for predicting a life event associated with a detected anomaly in accordance with one embodiment.

FIG. 13 is a flow chart of a process for detecting life events by applying anomaly detection methods to transaction data including the identification and use of validation transactions in accordance with one embodiment.

Common reference numerals are used throughout the FIGs. and the detailed description to indicate like elements. One skilled in the art will readily recognize that the above FIGs. are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., or described below. Rather, these exemplary embodiments are provided to allow a complete disclosure that conveys the principles of the invention, as set forth in the claims, to those of skill in the art.

The systems and methods of the present disclosure provide a technical solution to the technical problem of automatically, efficiently, and accurately identifying when a user of a data management system has been subject to a specific life event such as, but not limited to, a move, a job change, marriage, birth of a child, or the like. This is accomplished by applying machine learning-based anomaly detection methods to identify a change, or anomaly, in the user's streaming transaction/purchase activity representing a change in the user's purchases. If a threshold level of change in the user's transaction activity is detected, the user is then identified as potentially having experienced some form of life event. Using the disclosed embodiments, only after a user is identified as having potentially experienced some form of life event are individual user transactions processed and analyzed to determine the specific life event the user has most likely experienced. The user is then identified as having experienced the identified specific life event and this information is used to customize one or more interactions between the user and the data management system such as questions asked of the user, forms or displays provided to the user, or offers made to the user.

Using the disclosed embodiments, life event detection is performed based on identifying changes in the stream of the user's transaction/purchasing activity, as opposed to analyzing individual user transactions/purchases in isolation and comparing these with transaction/purchase types and changes pre-determined to be indicative of a specific life event. Therefore, and in contrast to traditional methods, using the disclosed embodiments a more holistic and systematic approach is taken which results in more accurate predictions. In addition, using the disclosed embodiments, analysis of individual transaction data, and the generation and comparison with user profiles, is eliminated for the vast majority of users.

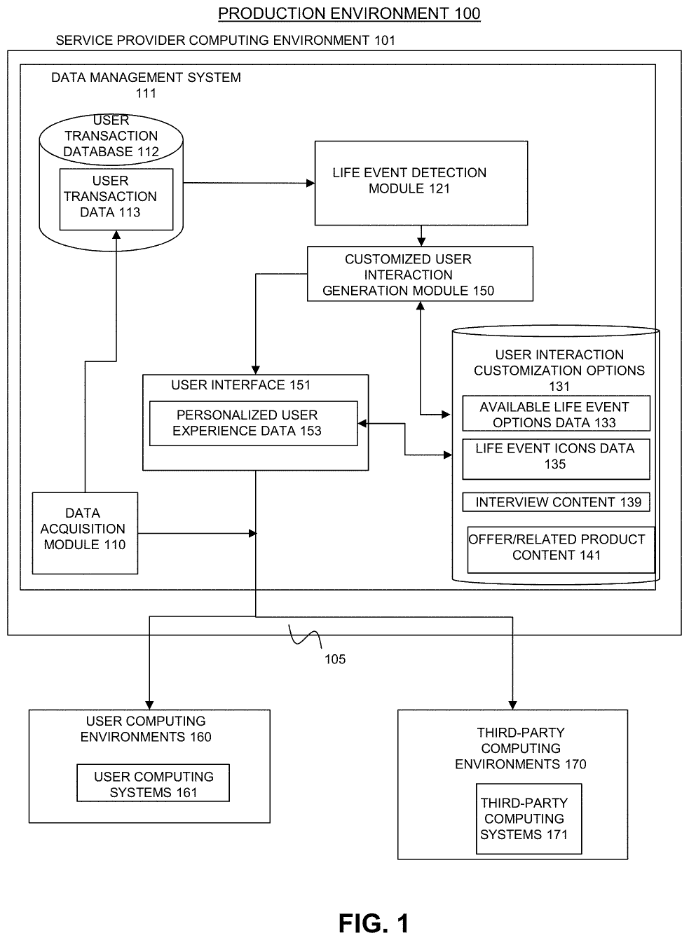

FIG. 1 is a high-level block diagram of a production environment 100 for implementing a system for detecting life events by applying anomaly detection methods to transaction data in accordance with one embodiment.

As seen in FIG. 1, production environment 100 includes service provider computing environment 101, user computing environments 160, and third-party computing environments 170, all communicatively coupled to one another via one or more communication channels, represented in FIG. 1 by communication channel 105.

Service provider computing environment 101 includes data management system 111. Data management system 111 can be any data management system as discussed herein, known in the art at the time of filing, or as made available after the time of filing. As a specific illustrative examples, data management system 111 can be one or more of a tax-preparation system, a business accounting system, a business inventory system, a business financial transaction management system, a personal financial management system, a personal financial transaction management system, or any other system that manages, processes, or otherwise manipulates transaction data associated with users of the data management system.

Data management system 111 includes user transaction database 112 including user transaction data 113. User transaction data 113 can be obtained from one or more transaction data sources including, but not limited to, user computing systems 161, which represents one or more computing systems associated with one or more users. Similarly, user transaction data 113 can be obtained from one or more third-party computing systems 171, which represents one or more third-party computing systems associated with one or more third parties.

The data management system 111 utilizes a data acquisition module 110 to retrieve user transaction data 113 related to the financial transactions of the users of the data management system 111. The data acquisition module 110 can be configured to use financial institution authentication data provided by the users (not shown) to acquire user transaction data 113 related to financial transactions of the users. In particular, the data acquisition module 110 uses the financial institution authentication data to log into the online services, or other third-party computing systems 171, to retrieve user transaction data 113 related to the financial transactions of users of the data management system 111. Accordingly, the financial institution authentication data can include usernames, passwords, bank account numbers, routing numbers, or other validation credentials needed to access online services of various banking institutions.

The user transaction data 113 can include debit card transactions, credit card transactions, credit card balances, bank account deposits, bank account withdrawals, credit card payment transactions, online payment service transactions such as PayPal transactions or other online payment service transactions, loan payment transactions, investment account transactions, retirement account transactions, mortgage payment transactions, rent payment transactions, bill pay transactions, budgeting information, financial goal information, or any other types of financial transactions. The user transaction data 113 can also include data related to withdrawals, deposits, and balances in the bank accounts of users.

Once access to the third-party computing systems 171 is obtained using the financial institution authentication data, user transaction data 113 can be obtained using one or more transaction data acquisition methods known to those of skill in the art, such as screen scraping, or any other method of obtaining user transaction data discussed herein, and/or as known in the art at the time of filing, and/or as made available after the time of filing.

As discussed in more detail below, the user transaction data 113 can include, for each financial transaction, one or more of: time stamp data corresponding to a time stamp that indicates the date and time of the financial transaction; location data representing the location of the transaction; amount data representing the amount of the transaction; and payee data representing the merchant or payee associated with the transaction. In addition, user transaction data 113 can include, for each financial transaction, description data indicating the items purchased or transaction category assigned to the transaction.

As discussed in more detail below, user transaction data 113 is provided to life event detection module 121. As also discussed in more detail below, at life event detection module 121 user transaction data 113 is analyzed to detect anomalies in the transactions represented by user transaction data 113. Detected anomalies are then treated as an indication that users associated with anomalous user transaction data are likely to have experienced one or more life events such as, but not limited to, moving, marriage, birth of a child, change of employment, etc. However, it should be noted that, in contrast to traditional methods, at this point in the disclosed embodiments, no individual transaction data is analyzed and therefore the specific type of life event experienced by the user remains unknown. All that is known at this point is that the user has likely experienced some type of life event.

As discussed in more detail below, once an anomaly is detected in the portion of user transaction data 113 associated with a given user, that user is identified, or tagged, as having potentially experienced one or more life events. Then, only after the user is identified having potentially experienced one or more life events using anomaly detection methods is the transaction data associated with the user further analyzed to determine the specific life event associated with the detected anomaly. Consequently, using the disclosed embodiments, and in contrast to traditional methods, the initial anomaly detection of life event detection module 121 serves as a gating function requiring a user be identified has having experienced some form of life event before significant individual transaction analysis is performed. Since most users' transaction data will not have a threshold level of anomaly, i.e., most users will not have experienced a life event in a given time frame, the disclosed embodiments represent a far more efficient system in terms of processing costs. In addition, since individual transactions are only processed after a user life event is detected by anomaly detection methods, the disclosed embodiments are subject to fewer false positives and negatives, i.e., provide more accurate predictions and results.

As discussed in more detail below, once the specific life event associated with the detected anomaly is identified by analysis of the transaction data associated with the user, the user is then identified, or tagged, as having experienced the identified specific life event.

As discussed in more detail below, once a user is determined to have experienced an identified specific life event, data indicating the identified specific life event is provided to customized user interaction generation module 150. Customized user interaction generation module 150 can then select one or more user interaction customization options associated with the identified specific life event from user interaction customization options 131.

The user interaction customization options included in user interaction customization options 131 can include, but are not limited to, providing customized interview content 139, such as tax preparation related questions and forms, customized to the identified specific life event associated with the user. Likewise, the user interaction customization options included in user interaction customization options 131 can include, but are not limited to, making the user aware of detected potential life events using available life event options data 133; presenting the user with one or more life event icons or other graphics from life event icons data 135; presenting the user with offers or contact information 141 for products or services associated with the identified specific life event; or any other user interaction customization options 131 that can be customized to one or more identified specific life events as discussed herein, or as known at the time of filing, or as become known after the time of filing.

Once customized user interaction generation module 150 has selected one or more user interaction customization options associated with the identified specific life event, customized user interaction generation module 150 uses the selected user interaction customization options to create a user experience personalized for the user in light of the identified specific life event, represented in FIG. 1 by personalized user experience data 153. The personalized user experience generated by personalized user experience data 153 is then presented to the user via user interface 151, and communication channel 105, at the user computing system of user computing systems 161 in user computing environments 160.

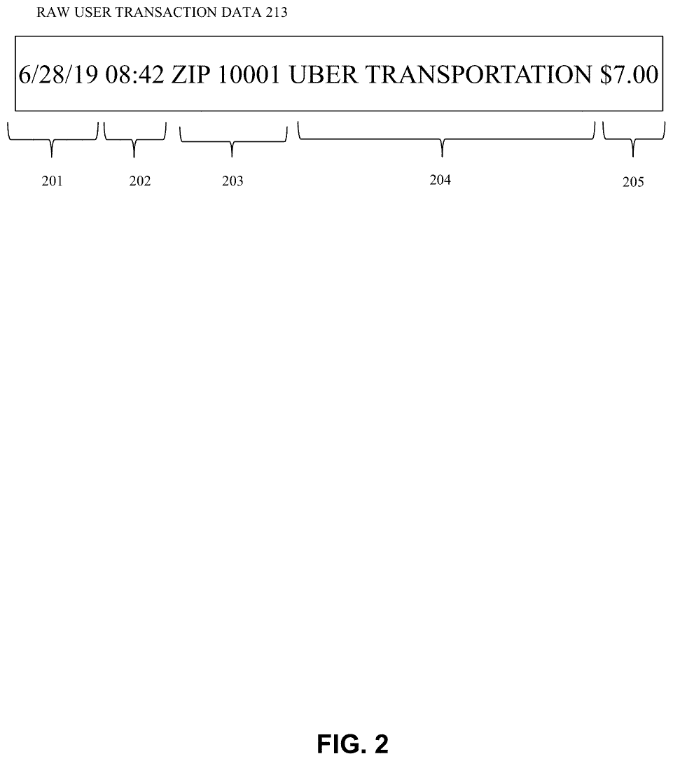

As noted above, user transaction data 113 is provided to life event detection module 121 to be analyzed and to detect anomalies in the transactions represented by user transaction data 113. FIG. 2 is an illustrative example of raw user transaction data 213 received by data management system 111 as user transaction data 113. For simplicity, in the specific illustrative example of FIG. 2, raw user transaction data 213 represents a single user transaction.

As seen in FIG. 2, raw user transaction data 213 includes: date data 201 indicating, in this specific illustrative example, a transaction date of Jun. 28, 2019 (6/28/19); time data 202 indicating, in this specific illustrative example, a transaction time of 8:42 AM (08:42); location data 203 indicating, in this specific illustrative example, a zip code of 10001 correlating to a transaction location of New York City; payee data 204, indicating, in this specific illustrative example, the transaction payee Uber Transportation; and amount data 205 indicating, in this specific illustrative example, a transaction amount of $7.00.

Typically, the raw transaction data obtained can include numerous formats, abbreviations and greater or fewer types of data. Consequently, as discussed in more detail below, raw transaction data 213 must typically undergo some form of formatting to generate consistent structured data for all user transactions.

Those of skill in the art will readily recognize that the various types of data, such as date and time data 201 and 202, location data 203, payee data 204, and amount data 205, shown in the specific illustrative example of FIG. 2 are merely representative of numerous types of data that may be included in raw user transaction data 213. In many cases, only a subset of the types of data shown in FIG. 2 may be present and, in other cases, more types of data can be present in raw transaction data 213.

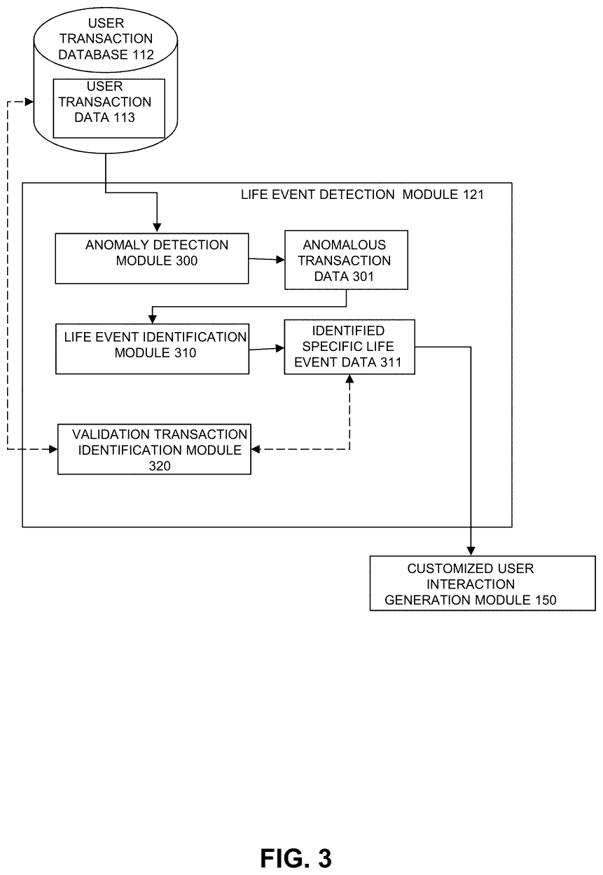

As noted above, user transaction data 113, including data representing multiple user transactions such as raw user transaction data 213, associated with multiple users is provided to life event detection module 121. FIG. 3 is a more detailed block diagram of a life event detection module 121. As seen in FIG. 3, life event detection module 121 includes anomaly detection module 300 which identifies anomalies in the user transaction data 113 associated with a given user.

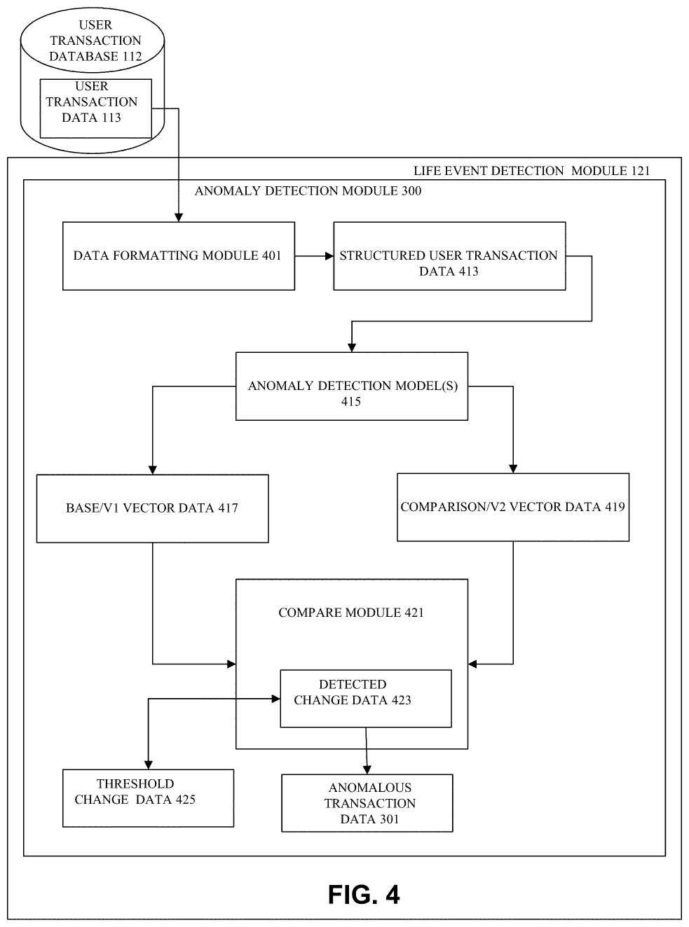

FIG. 4 is a block diagram of an anomaly detection module 300 included in a life event detection module 121. An exemplary structure and operation of anomaly detection module 300 will now discussed with reference to FIGS. 1, 2, 3, 4, 5A, 5B, 6A, 6B, and 7.

In order for user transaction data 113 to be analyzed by anomaly detection module 300 it may be necessary to process raw user transaction data, such as raw user transaction data 213, obtained by data acquisition module 110 of data management system 111 to generate element-based structured representations of the transactions included in the raw user transaction data 213. To this end, the raw user transaction data 213 can be parsed, or otherwise processed, by data formatting module 401 of anomaly detection module 300 to identify defined elements within the raw user transaction data 213 and generate structured user transaction data 413.

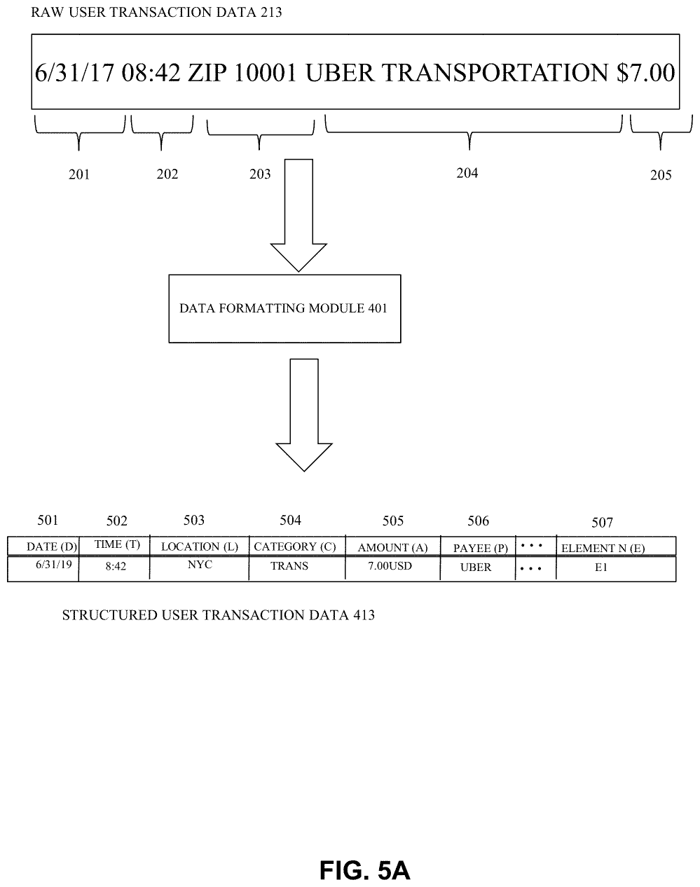

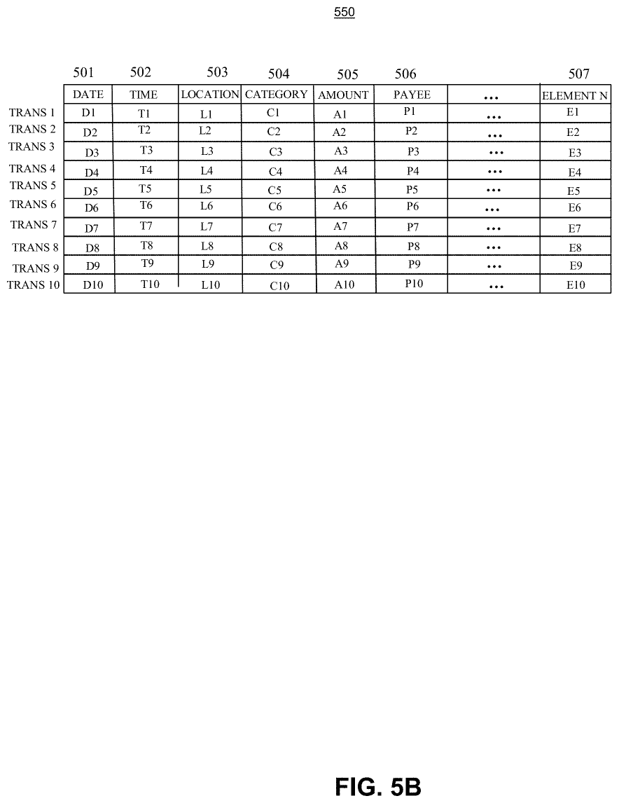

FIG. 5A is an illustrative example of raw user transaction data 213 of FIG. 2 and the associated structured user transaction data 413 generated by data formatting module 401.

Referring to FIGS. 2, 4, and 5A, raw user transaction data 213 is processed by data formatting module 401 to generate structured user transaction data 413. Structured user transaction data 413 includes; date data (D) in column 501 derived from date data 201 of raw user transaction data 213; time data (T) in column 502 derived from time data 202 of raw user transaction data 213; location data (L) in column 503 derived from location data 203 of raw user transaction data 213; category data (C) in column 504 derived from payee data 204 of raw user transaction data 213; amount data (A) in column 505 derived from amount data 205 of raw user transaction data 213; and payee data (P) in column 506 derived from payee data 204 of raw user transaction data 213.

As noted above with respect to FIG. 2, the various types of data, such as date and time data 201 and 202, location data 203, payee data 204, and amount data 205, shown in the specific illustrative example of raw user transaction data 213 of FIG. 2 are merely representative of numerous types of data that may be included in raw user transaction data 213. In many cases, only a subset of the types of data shown in FIG. 2 may be present and, in other cases, more types of data can be present in raw transaction data 213.

It follows that the data elements such as date data (D), time data (T), location data (L), category data (C), amount data (A), and payee data (P) derived from raw user transaction 213 are merely representative of numerous types of data that may be included in structured user transaction data 413. This situation indicated in FIG. 5A by element N data (E) in column 507 of structured user transaction data 413. Any number of data elements, up to “N” elements, can be included in structured user transaction data 413. Element N data (E) in column 507 of structured user transaction data 413 is therefore representative of various other structured data elements that can be derived from other examples of raw user transaction data 213.

Using the disclosed embodiments, multiple user transactions are processed. Therefore, in operation, structured user transaction data 413 includes multiple structured user transactions.

FIG. 5B is a table 550 of multiple structured user transactions, i.e., trans 1 through trans 10. Each of trans 1 through trans 10 in table 550 is a structured user transaction and therefore is similar in format to the illustrative structured user transaction depicted in FIG. 5A. Each of trans 1 through trans 10 in table 550 is obtained from a stream of transactions associated with a specific illustrative user for anomaly detection by anomaly detection module 300.

In FIG. 5B each of the data elements of the various types, or series, are representative of a specific value, such as the specific values shown in FIG. 5A. Each of trans 1 through trans 10 in table 550 has a common structure that is identical to the structure of structured user transaction data 413 of FIG. 5A. However, for simplicity of illustration, in FIG. 5B the specific values in columns 501, 502, 503, 504, 505, 506 and 507, are represented by letters correlating to a specific type of value and a number correlating to the specific transaction. Consequently, as an example, the transaction represented by “trans 1” includes D1 in column 501 representing specific date data, T1 in column 502 representing specific time data, L1 in column 503 representing specific location data, C1 in column 504 representing specific category data, A1 in column 505 representing specific amount data, P1 in column 506 representing specific payee data, and E1 in column 507 representing specific element N data.

Using the representation scheme of this specific illustrative example, table 550 includes structured user transaction element data for ten transactions, represented as trans 1 through trans 10. As also seen in FIG. 5B, each of trans 1 through trans 10 includes respective date data of a “D” series, i.e., D1 through D10; respective time data of a “T” series, i.e., T1 through T10; respective location data of a “L” series, i.e., L1 through L10; respective category data of a “C” series, i.e., C1 through C10; respective amount data of an “A” series, i.e., A1 through A10, and other data elements up to respective element N data of an “E” series, i.e., E1 through E10.

Of note, each of the data elements of the various types or series is defined to be potentially associated with one or more life events. For instance, a change the date and time elements, i.e., the D and T series elements, can indicate a change in the user's routine such as a change in time zone or working hours. Likewise, a change the location elements, i.e., the L series elements, can indicate a move or change in job location. Similarly, a change in the C or P series elements, i.e., a change in the category of transactions or the type of payee associated with transactions, can be indicative of new purchasing patterns, for example purchases of items associated with child rearing or home ownership. Finally, in this specific illustrative example, a change in amount elements, i.e., the A series elements can also indicate new purchasing patterns, for example purchases of more items associated with child rearing or home ownership.

As seen in FIG. 4, once structured user transaction data 413 is generated by data formatting module 401, at least part of structured user transaction data 413 is used as input data to one or more anomaly detection models 415. Anomaly detection models 415 represent any of the numerous machine learning anomaly detection algorithms/models know to those of skill in the art.

As specific illustrative examples, anomaly detection models 415 can be DBSCAN, CARE, or Isolations forest anomaly detection models. In other examples, anomaly detection models 415 can be any other anomaly detection models as discussed herein, or as known in the art at the time of filing, or as become known after the time of filing that can detect anomalies in user transaction data.

In one example, anomaly detection models 415 of FIG. 4 are used to generate vector data, such as base/v1 vector data 417 and comparison/v2 vector data 419. Base/v1 vector data 417 and comparison/v2 vector data 419 are generated based on the structured user transaction data 413 for specific users at different times/dates or based on different numbers of transactions represented in structured user transaction data 413.

For instance, anomaly detection models 415 may initially use a portion of structured user transaction data 413 representing transactions taking place in a specific time frame, such as the previous month, to generate base/v1 vector data 417. Alternatively, anomaly detection models 415 may initially use the last 100, 1000, or any designated number, of transactions represented in structured user transaction data 413, to generate base/v1 vector data 417.

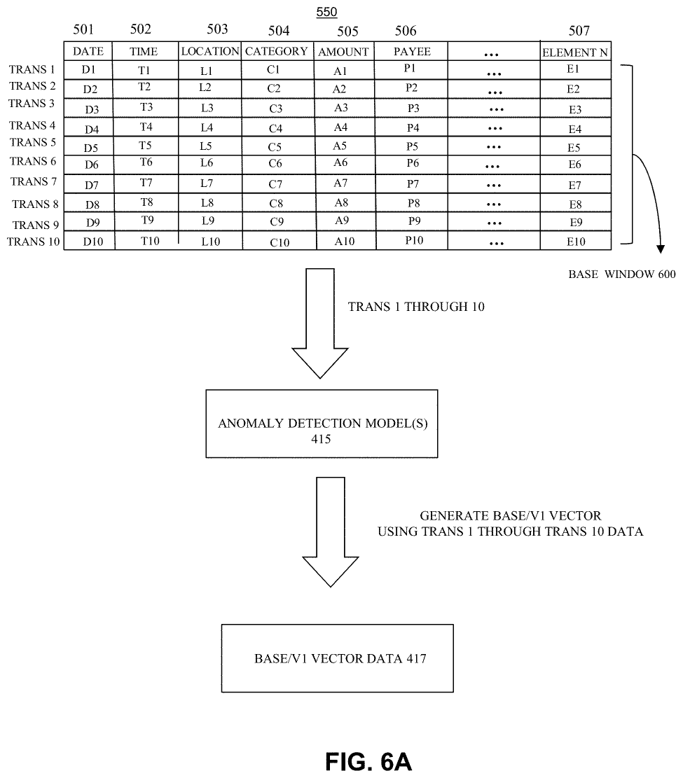

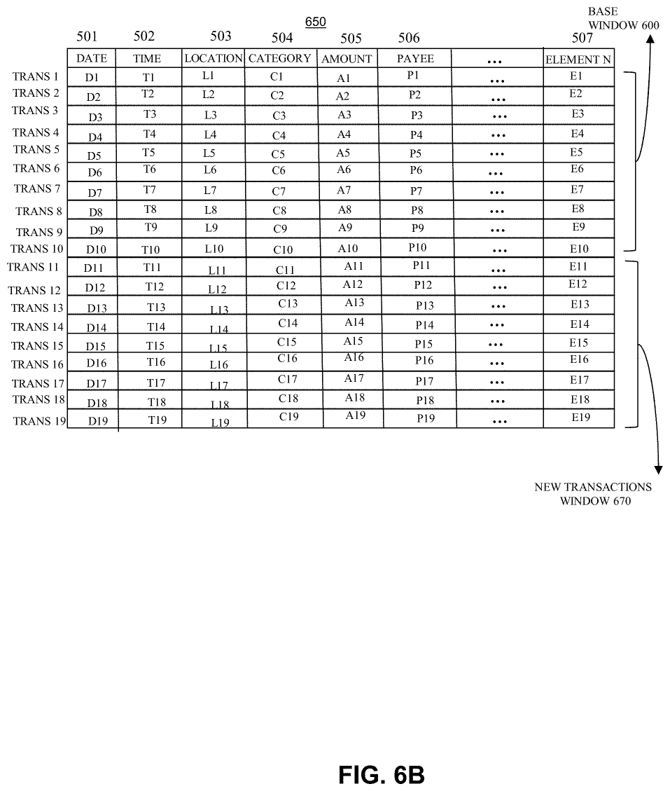

FIG. 6A, is a high-level illustration of the entire set of structured user transaction data 413 of table 550 of FIG. 5B being used by anomaly detection models 415 to generate base/v1 vector data 417. As seen in FIG. 6A, in this specific illustrative example, the selected base window 600 used to generate base/v1 vector data 417 includes all the transactions, i.e., trans 1 through trans 10, of table 550.

As noted above, base window 600 can be determined based on the date of the transactions, i.e., the “D” series data of trans 1 through trans 10 of table 550 or on the number of transactions, in this specific example the last 10 transactions.

Once base/v1 vector data 417 is generated by anomaly detection models 415, comparison/v2 vector data 419 is generated by anomaly detection models 415. As noted above, base/v1 vector data 417 and comparison/v2 vector data 419 differ in the portion of structured user transaction data 413 used to generate base/v1 vector data 417 and comparison/v2 vector data 419. The difference in the portions of structured user transaction data 413 used can be based on defining a base widow of transactions in structured user transaction data 413 to generate base/v1 vector data 417 and a different comparison window to generate comparison/v2 vector data 419.

As noted, the base and comparison windows used to generate base/v1 vector data 417 and comparison/v2 vector data 419 can be determined based on the dates of the transactions, numbers of immediately preceding transactions, or any other window defining parameter desired. As a specific illustrative example, the base window of transactions used to generate base/v1 vector data 417 can be all or any transactions having a date preceding a defined date or falling within a defined time period such as a month. In this case, the comparison window of transactions used to generate comparison/v2 vector data 419 can be all or any transactions having a date subsequent to the defined date or falling within a defined time period such as a month, after, or overlapping with, the base window.

In operation, the base window and comparison window can be a single sliding window that shifts as new structured user transaction data 413 representing new user transactions is obtained. Of note is the fact that it is desirable in many cases that the base window and comparison window be large enough, and/or overlap, so that the effect of outlier transactions in structured user transaction data 413 on the process is minimized.

FIG. 6B shows a table 650 of structured user transaction data 413. Table 650 includes base window 600 and the transactions trans 1 through trans 10 of FIG. 6A as well as new transactions, i.e., trans 11 through trans 19 of new transactions window 670. In one example, new transactions window 670 can be used as the comparison window used to generate comparison/v2 vector data 419. However, as noted above, it is often desirable to use a sliding or overlapping window of transactions as the comparison window used to generate comparison/v2 vector data 419.

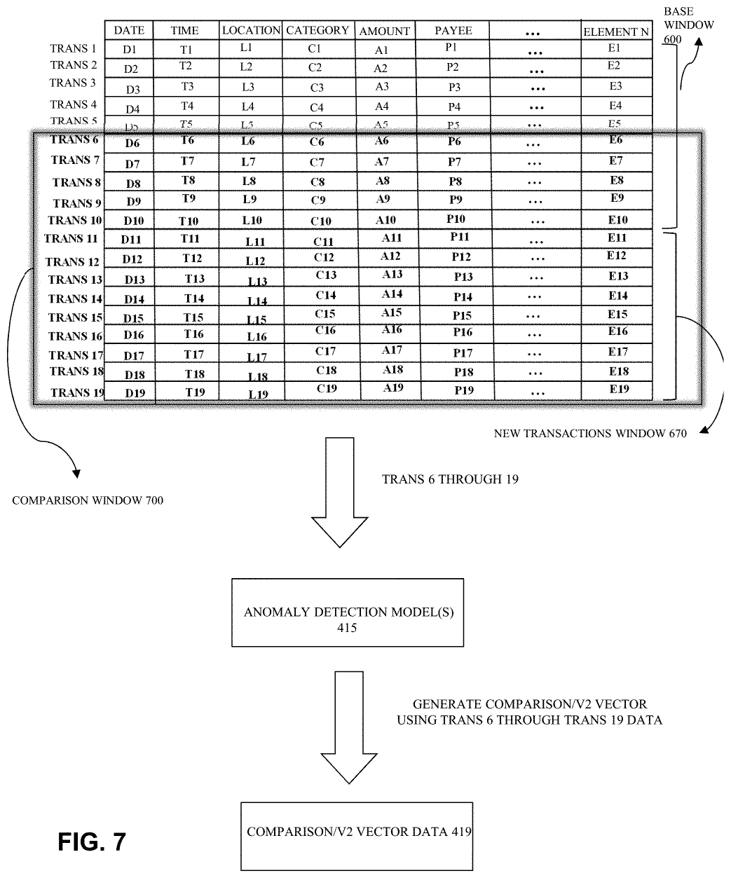

FIG. 7 is a high-level diagram of a comparison window 700 including multiple structured user transactions, i.e., trans 6 through trans 19, obtained from a stream of transactions associated with the specific illustrative user of FIGS. 6B and 6C. Illustrated in FIG. 7 is trans 6 through trans 19 of comparison window 700 being used by anomaly detection models 415 to generate comparison/v2 vector data 419. FIG. 7 shows the table 650 of structured user transaction data 413 of FIG. 6B along with a sliding and overlapping comparison window 700 used to generate comparison/v2 vector data 419 by anomaly detection models 415.

As seen in FIG. 7, comparison window 700 is selected to include the transactions trans 6 to trans 10 used, in part, to generate base/v1 vector data 417 of FIG. 6A and transactions trans 7 through trans 19 of new transactions window 670. Consequently, comparison window 700 is a sliding window capturing transactions trans 6 through trans 19 that include overlapping transactions trans 6 through trans 10. In this way, comparison/v2 vector data 419 is less likely to be susceptible to an outlier transaction.

As also seen in FIG. 7, the transaction data included in comparison window 700 of FIG. 7 is used by anomaly detection models 415 to generate comparison/v2 vector data 419. Like base window 600, comparison window 700 of FIG. 7 can be determined based on the date of the transactions, i.e., the “D” series data of trans 6 through trans 19 of table 650 or on the number of transactions, in this specific example the last 14 transactions.

Returning to FIG. 4, once base/v1 vector data 417 and comparison/v2 vector data 419 are generated, base/v1 vector data 417 and comparison/v2 vector data 419 are provided to compare module 421 where base/v1 vector data 417 and comparison/v2 vector data 419 are processed to detect differences/changes in base/v1 vector data 417 and comparison/v2 vector data 419, as represented by detected change data 423.

Once detected change data 423 is generated, the detected change represented by detected change data 423 is compared with threshold change data 425. Threshold change data 425 represents a maximum expected level of change in base/v1 vector data 417 and comparison/v2 vector data 419 absent a life event, i.e., a maximum allowable non-life event related value of detected change data 423. In one example, if the value represented in detected change data 423 is greater than the value represented by threshold change data 425, then the user associated with base/v1 vector data 417 and comparison/v2 vector data 419 is labeled as a user likely having experienced an as yet undefined, or generic, life event.

Once a user is labeled as a user likely having experienced a generic life event, the user transaction data 113 associated with that user used to generate base/v1 vector data 417 and comparison/v2 vector data 419 is collected as anomalous transaction data 301. Anomalous transaction data 301 is then provided to life event identification module 310 of FIG. 3.

As seen in FIG. 3, life event detection module 121 includes life event identification module 310. As noted, when a threshold anomaly is detected in the user transaction data 113 associated with the given user by anomaly detection module 300, anomalous transaction data 301 is generated that includes the user transaction data 113 associated with the user and the detected anomaly, e.g., the user transaction data 113 associated with the user used to generate base/v1 vector data 417 and comparison/v2 vector data 419.

In one example, once a user is identified has having potentially experienced a life event by anomaly detection module 300, the user's transaction data of anomalous transaction data 301 is analyzed at life event identification module 310 by humans to determine if the user has indeed experienced an associated life event and what specific type of life event the user has experienced. The user is then identified, or tagged, as having experienced the identified specific life event and identified specific life event data 311 is generated representing the identified specific life event.

In one example, once enough anomalous transaction data 301 is analyzed to identify the specific life event the user has experienced and respective identified specific life event data 311 is generated, the pairs of anomalous transaction data 301 and identified specific life event data 311 can be used as training data for one or more machine learning-based machine learning-based life event identification models.

Any of the various known classification models, or any other known supervised models, can be utilized as machine learning-based life event identification models. As specific illustrative examples, the machine learning-based life event identification models can be one or more of Decision Tree, Random Forest, Multi-class Logistic Regression, or SVM machine learning-based classification models. In other cases, the machine learning-based life event identification models can be any classification models as discussed herein or known in the art at the time of filing, or as become known after the time of filing.

In general, classifier models are well known machine learning models that are trained to classify data items as belonging to one of multiple categories. Classifiers are trained with a set of labeled data items. The data items are labeled according to a classification. Classifiers are trained to correctly reproduce the known labels of the labeled data items. After the training process, classifiers can accurately classify many data items that are typical of the data items from the training set.

Using these well-known machine leaning methods, systems, and algorithms, one or more machine learning-based life event identification models can be trained based on the characteristics of the anomalous transaction data 301 and the identified specific life event data 311 of historical users. Then, when an anomaly is detected in the user transaction data 113 of a subsequent user and the subsequent user is identified as having experienced a generic life event, the anomalous transaction data 301 associated with subsequent user and detected anomaly is provided to the trained one or more machine learning-based life event identification models. The trained one or more machine learning-based life event identification models then process the anomalous transaction data 301 associated with subsequent user to make predictions regarding the specific life event the user has likely experienced.

To this end, once the one or more machine learning-based life event identification models are trained, they can be deployed in life event identification module 310 and future anomalous transaction data 301 can be processed by the trained machine learning-based life event identification models of life event identification module 310 and probabilistically associated with a specific life event. In these examples, if a determination is made at life event identification module 310 that a probability that the user has experienced an associated life event is greater than a threshold value, the user is then identified, or tagged, as having experienced the associated specific life event without need of further human analysis.

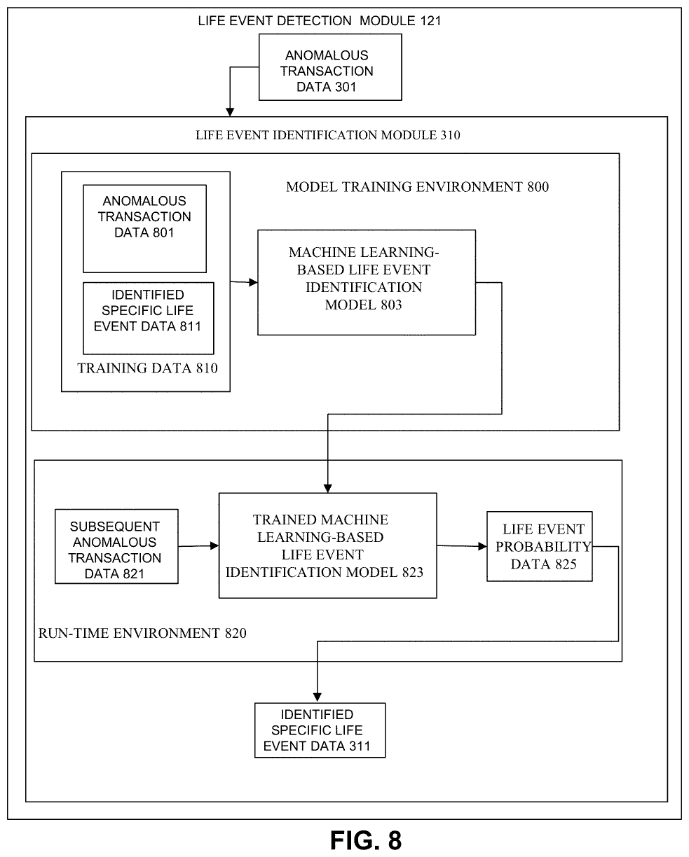

FIG. 8 is a high-level diagram of a life event identification module 310, including trained machine learning-based life event identification model 823, implemented in a life event detection module 121.

Referring to FIGS. 1, 3 and 8, at life event identification module 310, the specific life events associated with the detected anomalies are initially identified or determined using human analysts. In these initial cases, the human analysts look over the anomalous transaction data 301 and make a determination as to the most likely life event associated with the anomalous transaction data.

As a specific illustrative example, human analysts can determine by analyzing anomalous transaction data 301 that a threshold number of the user transactions are taking place at locations that are different than the historical locations associated with the user's transactions and that the different locations are largely centered around a common new location. In this case, the human analysts will likely determine that the user has moved. Therefore, identified specific life event data 311 is generated to indicate the detected anomalous transaction data 301 is associated with a user move.

Likewise, human analysis of transaction data 301 may determine that the user transaction data indicates a threshold number of purchases associated with child related products and/or include merchant payees identified as selling child related products. In this case, human analysis will identify that the specific life event associated with the user is the birth of a child. Therefore, identified specific life event data 311 is generated to indicate the detected anomalous transaction data 301 is associated with the user having a baby.

Once enough human analysis is conducted on enough anomalous transaction data 301 associated with enough users, and the human identified or determined likely life events indicated in the associated identified specific life event data 311 are verified, the pairs of anomalous transaction data 301 and identified specific life event data 311 are collected as training data 810 including anomalous transaction data 801 and identified specific life event data 811. Training data 810 is then used to train one or more machine learning models, such as machine learning-based life event identification model 803, in model training environment 800.

As an example, the anomalous transaction data 801 can be used as input object data and the identified and verified associated specific life events of identified specific life event data 811 can be used as labels or supervisory signals. This data can then be used in model training environment 800 to train one or more machine learning models, such as machine learning-based life event identification model 803 or any other known machine learning-based classifiers, to identify probabilities that specific life events are associated with respective detected anomaly data.

As noted above, machine learning-based life event identification model 803 can be any of the various known classification models, or any other known supervised model. As specific illustrative examples, machine learning-based life event identification model 803 can be one or more of Decision Tree, Random Forest, Multi-class Logistic Regression, or SVM machine learning-based life event identification models. In other cases, machine learning-based life event identification model 803 can be any classification models as discussed herein or known in the art at the time of filing, or as become known after the time of filing.

Once the anomalous transaction data 801 and identified specific life event data 811 are used to train machine learning-based life event identification model 803 in model training environment 800, the resulting trained machine learning-based life event identification model 823 is implemented in runtime environment 820. In runtime environment 820, subsequent anomalous transaction data 821 associated with a subsequent user identified as having experienced a life event is provided to machine learning-based life event identification model 823.

Machine learning-based life event identification model 823 then analyzes subsequent anomalous transaction data 821 and generates life event probability data 825 including probability scores representing probabilities the user has experienced specific life events.

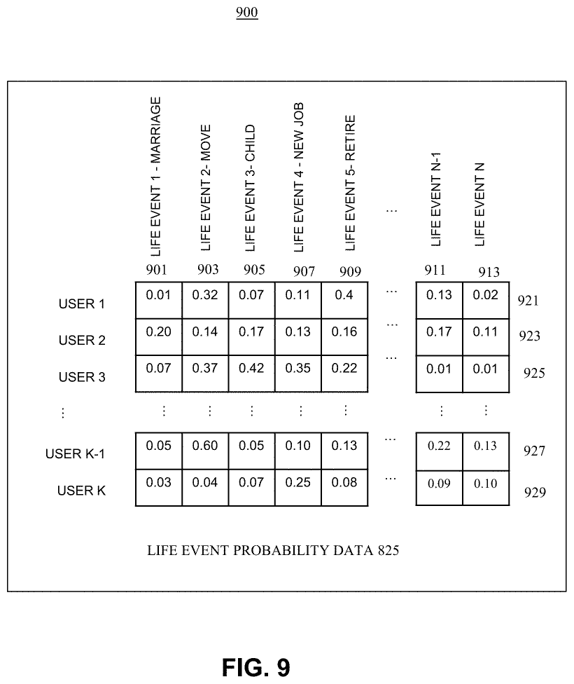

FIG. 9 shows an illustrative example of life event probability data 825 generated by machine learning-based life event identification model 823 for multiple users, i.e., user 1 through user K, based on analysis of the subsequent anomalous transaction data 821 associated with those users. In the specific illustrative example of FIG. 9, life event probability data 825 is arranged in life event probability score table 900.

Referring to FIGS. 1, 3, 4, 8 and 9 together, life event probability score table 900 of FIG. 9 includes life event columns associated with potential life events, i.e., marriage column 901, move column 903, child column 905, new job column 907, retire column 909, and any life events desired and defined as represented by N−1 and N columns 911 and 913. As also seen in FIG. 9, life event probability data 825 includes rows 921, 923, 925, 927 and 929 with each row being associated with a respective one of user 1 through user K.

As noted above, each of the users 1 through K has previously been identified as having experienced some type of life event based on anomalies detected in the respective portions of user transaction data 113 associated with each of the users 1 through K by anomaly detection module 300. Once identified as users having potentially experienced some type of life, the subsequent anomalous transaction data 821 associated with each of user 1 through user K is provided to machine learning-based life event identification model 823 and life event probability data 825 is generated by calculating a probability score for each potential life event represented in columns 901 through 913 for each of user 1 through user K.

In the specific illustrative example of FIG. 9, life event probability score table 900 includes, for each of user 1 through user K and each possible life event in columns 901 through 913, a probability score representing a prediction that the user has experienced a specific life event, i.e., a probability the user should be classified as a user having experienced the specific life event listed in columns 901 through 913. Each prediction score includes a value between 0 and 1. The higher the prediction score, the greater the probability that the user has experienced the respective specific life event of columns 901 through 913.

The data management system 111 can determine, for each of the K users, the specific life event with the highest probability score. Accordingly, for user 1, the most likely life event would be retirement, or “life event 5—retire,” which has a prediction score of 0.40. For user 2, the most likely life event would be marriage, or “life event 1—marriage,” which has a prediction score of 0.20. For user 3, the most likely life event would be having a child, or “life event 3—child,” which has a prediction score of 0.42. For user K−1, the most likely life event would be move, or “life event 3—move,” which has a prediction score of 0.60. For user K, the most likely life event would be new job, or “life event 4—new job,” which has a prediction score of 0.25.

In some instances, the probability score representing a prediction that the user has experienced a specific life event is compared with a pre-defined threshold value. Then, only if the calculated the probability score representing a prediction that the user has experienced a specific life event is greater the threshold value is the user identified as having experienced the specific life event.

Continuing with the specific illustrative example of FIG. 9, if the pre-defined threshold value is 0.50, then only user K−1 would be assigned or tagged with the corresponding life event. As noted above, in this case the life event assigned to user K−1 would be move, or “life event 3—move,” which has a prediction score of 0.60, the only prediction score in this example that exceeds the 0.50 threshold value.

Those of skill in the art will readily recognize that the specific life events, the specific type of life event probability data 825, and the specific arrangement of life event probability data 825 in life event probability score table 900 discussed above, and illustrated in FIG. 9, are but illustrative examples. Consequently, numerous variations to the specific life events, the specific type of life event probability data 825, and the specific arrangement of life event probability data 825 in life event probability score table 900 discussed above and illustrated in FIG. 9 are possible and the specific illustrative example of FIG. 9 does not limit the scope of the disclosed embodiments as set forth in the claims.

Returning to FIG. 8, the life event probability data 825 generated by machine learning-based life event identification model 823 is used to generate identified specific life event data 311. Identified specific life event data 311 represents the specific life event determined to be most probable by machine learning-based life event identification model 823, and, in one example, exceeding the threshold value for the identified specific life event.

Once the specific life event associated with the detected anomaly is determined and identified specific life event data 311 is generated, the user is then identified, or tagged, as having experienced the specific life event represented in identified specific life event data 311. Once a user is identified as having experienced the specific life event identified specific life event data 311, identified specific life event data 311 is provided to customized user interaction generation module 150 of FIG. 1. Customized user interaction generation module 150 can then select one or more user interaction customization options associated with the identified specific life event from user interaction customization options 131 as discussed above.

In some embodiments, it is desirable to add an additional layer of certainty that the identified specific life event is indeed the correct specific life event to associate with the user. As a specific illustrative example of when this additional layer of analysis may be desired, if a determined most probable specific life event associated with the detected anomaly in the user's transaction data is still not determined to be more probable than a threshold value, then an additional layer of certainty may be used to either generally increase the likelihood that the identified life event is correct, or, in some instances increase the calculated probability that the identified specific life event is correct above a threshold value.

As noted above with respect to FIG. 3, validation transaction identification module 320 can be used in these cases to provide further indication that the identified specific life event is the correct life event. To this end, validation transaction identification module 320 further processes user transaction data 113 associated with the user to identify specific user transactions that are determined to be associated with the identified specific life event.

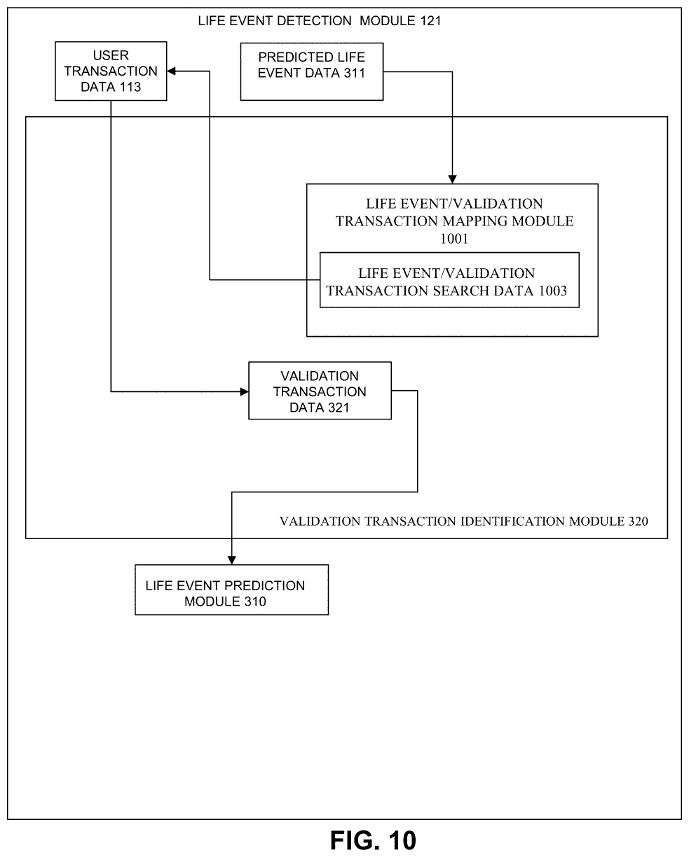

FIG. 10 is a high-level diagram of an optional validation transaction identification module 320 included in a life event detection module 121.

As noted above, in one embodiment, if a specific life event is identified as associated with the detected anomaly in the user's transaction data, validation transaction identification module 320 is used to provide further indication that the identified specific life event is the correct life event. To this end, validation transaction identification module 320 includes life event/validation transaction mapping module 1001. Life event/validation transaction mapping module 1001 includes data mapping specific life events to key terms that may appear in user transaction data. The key terms can be words describing items purchased, merchant names, or any other words/data that indicates that a given transaction may be associated with a given life event.

As a specific illustrative example, the words “diaper,” “baby,” “infant,” or the like in the description data of a transaction can be mapped to the life event of “having a child.” Likewise, the words “Home Depot,” “Lowes,” “Ace Hardware,” “mortgage,” “title company,” or the like in the payee data of a transaction may be mapped to the life event of home purchase.

As seen in FIG. 10, once identified specific life event data 311 representing the identified specific life event associated with a given user is generated by life event identification module 310, identified specific life event data 311 is provided to life event/validation transaction mapping module 1001 of validation transaction identification module 320. At life event/validation transaction mapping module 1001 key terms associated with the life event indicated by identified specific life event data 311 are collected as life event/validation transaction search data 1003.

The key terms of life event/validation transaction search data 1003 associated with the life event indicated by identified specific life event data 311 can then be used to search the portion of user transaction data 113 associated with the user for transactions including the key terms. Data representing any transactions associated with the user that include the key terms identified in user transaction data 113 are then collected as validation transaction data 321.

Validation transaction data 321 is then provided to life event identification module 310 for further analysis. At life event identification module 310 validation transaction data is analyzed to determine both the quantity and quality of the validation transactions included in validation transaction data 321. The results of this analysis can then be used to further confirm, or increase, the determined likelihood that the predicted life event of identified specific life event data 311 is the correct life event to be associated with the user.

Returning to FIG. 3, once the identified specific life event associated with the detected anomaly is determined, with or without the implementation of optional validation transaction identification module 320, the user is then identified, or tagged, as having experienced the life event. Once a user is identified as having experienced a specific life event, data indicating the identified specific life event is provided to customized user interaction generation module 150 of FIG. 1. Customized user interaction generation module 150 can then select one or more user interaction customization options associated with the identified specific life event from user interaction customization options 131.

As noted above, the user interaction customization options included in user interaction customization options 131 can include, but are not limited to, providing interview content, such as tax preparation related questions and forms, customized to the identified specific life event associated with the user, and presenting the user with offers or contact information for products or services associated with the identified specific life event.

As a specific illustrative example, in the instance where the data management system 111 is a tax-preparation system, if the identified specific life event was the life event of having a child, the interview content provided to the user can be modified to include questions regarding child dependency deductions, hospital costs, daycare costs, loss of income of career change experienced by one of the parents, etc. Similarly, in this specific illustrative example where the data management system 111 is a tax-preparation system and the identified specific life event was the life event of having a child, the user could be presented with offers for child related products, services such as daycare, or any other child related products or services.

Once customized user interaction generation module 150 has selected one or more user interaction customization options associated with the identified specific life event, customized user interaction generation module 150 uses the selected user interaction customization options to create a personalized user experience for the user, represented in FIG. 1 by personalized user experience data 153. The personalized user experience dictated by personalized user experience data 153 is then presented to the user via user interface 151 at the user computing system of computing systems 161 in user computing environments 160 via communication channel 105.

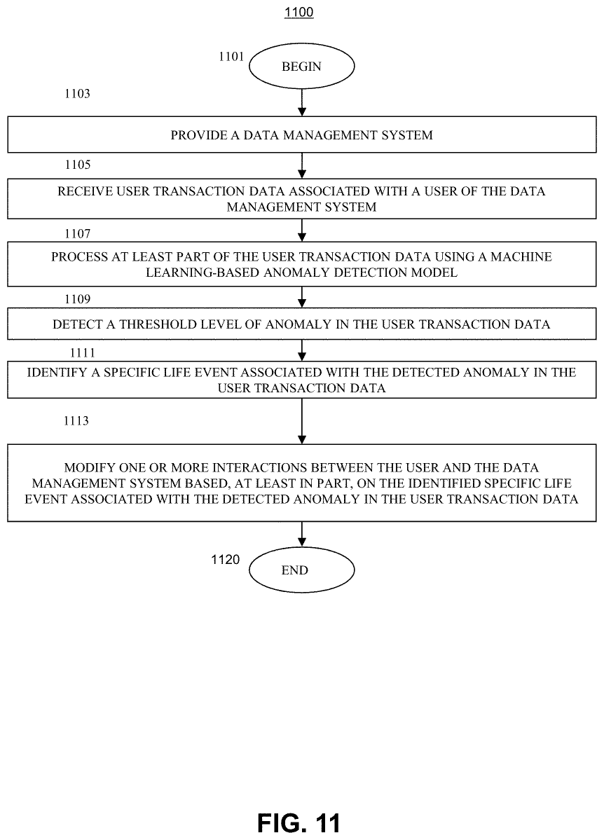

FIG. 11 is a flow chart representing a process 1100 for detecting life events by applying anomaly detection methods to transaction data in accordance with one embodiment. As seen in FIG. 11, process 1100 begins at operation 1101 and process flow proceeds to operation 1103.

At operation 1103 a data management system such as any of the data management systems discussed herein with respect to FIG. 1 or known in the art at the time of filing, or as become known after the time of filing, is provided to one or more users.

Once a data management system is provided at operation 1103, process flow proceeds to operation 1105.

At operation 1105, user transaction data, such as discussed herein with respect to FIG. 1 and FIG. 2, is obtained using any of the methods, and from any of the sources, discussed herein with respect to FIG. 1 and FIG. 2, or known in the art at the time of filing, or as become known after the time of filing.

Once user transaction data is received at operation 1105, process flow proceeds to operation 1107.

At operation 1107, the user transaction data of operation 1105 is processed using any of the machine learning-based anomaly detection models or techniques discussed herein with respect to FIGS. 4, 5A, 5B, 6A, 6B, and 7.

Once the user transaction data is processed using machine learning-based anomaly detection models or techniques at operation 1107, process flow proceeds to operation 1109.

At operation 1109, a threshold level of anomaly is detected in the user transaction data associated with the user using any of the machine learning-based anomaly detection models or techniques discussed herein with respect to FIGS. 4, 5A, 5B, 6A, 6B, and 7.

Once a threshold level of anomaly is detected in the user transaction data associated with the user at operation 1109, process flow proceeds to operation 1111.

At operation 1111 the transaction data associated with the detected threshold level of anomaly in the user transaction data is analyzed to identify a specific life event associated with the detected anomaly using any of the human or machine-based methods discussed herein with respect to FIGS. 4, 5A, 5B, 6A, 6B, 7 and 8.

Once a specific life event associated with the detected anomaly in the user transaction data is identified at operation 1111, process flow proceeds to operation 1113.

At operation 1113, one or more of the interactions between the user and the data management system are customized based on the identified specific life event associated with the detected anomaly in the user transaction data. The customizations can include any of the modifications/customizations discussed herein with respect to FIG. 1, or as known in the art at the time of filing, or as become known after the time of filing.

Once, one or more interactions between the user and the data management system are customized based, at least in part, on the identified specific life event associated with the detected anomaly at operation 1113, process flow proceeds to end operation 1120 and process 1100 is exited to await new data.

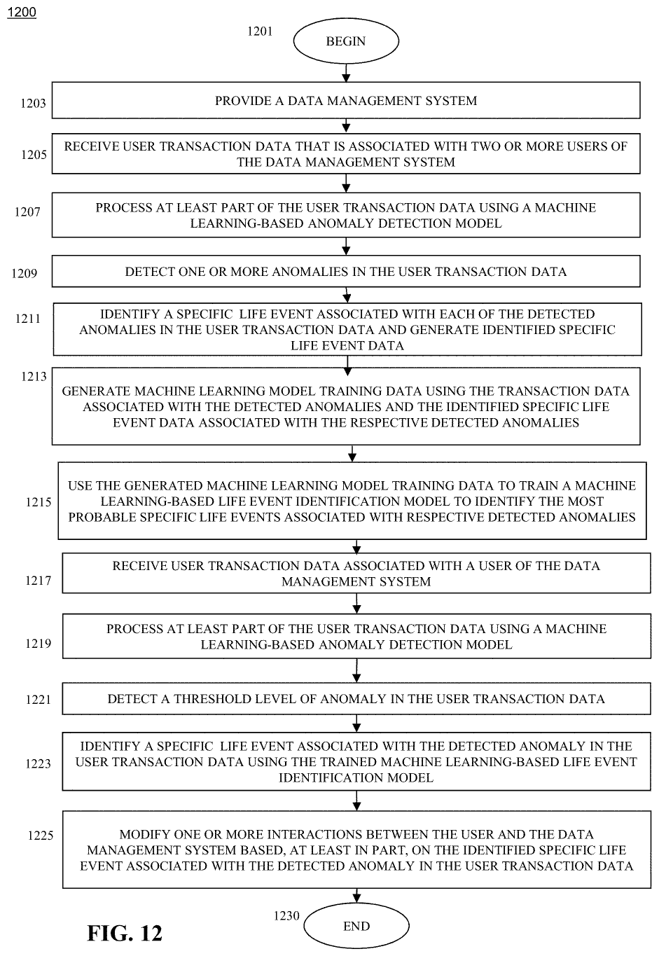

FIG. 12 is a flow chart representing a process 1200 for detecting life events by applying anomaly detection methods to transaction data including the training and use of a machine learning-based model for predicting a life event associated with a detected anomaly.

As seen in FIG. 12, process 1200 begins at operation 1201 and process flow proceeds to operation 1203.

At operation 1203 a data management system such as any of the data management systems discussed herein with respect to FIG. 1 or known in the art at the time of filing, or as become known after the time of filing, is provided to one or more users.

Once a data management system is provided at operation 1203, process flow proceeds to operation 1205.

At operation 1205, user transaction data such as discussed herein with respect to FIG. 1 and FIG. 2, for two or more users is obtained using any of the methods, and from any of the sources, discussed herein with respect to FIG. 1 and FIG. 2, or known in the art at the time of filing, or as become known after the time of filing.

Once user transaction data associated with two or more users is received at operation 1205, process flow proceeds to operation 1207.

At operation 1207, at least part of the user transaction data associated with the at least two or more users is processed using any of the machine learning based anomaly detection models or techniques discussed herein with respect to FIGS. 4, 5A, 5B, 6A, 6B, and 7.

Once at least part of the user transaction data associated with the at least two or more users is processed using machine learning based anomaly detection techniques at operation 1207, process flow proceeds to operation 1209.

At operation 1209, one or more threshold levels of anomaly are detected in the user transaction data associated with the two or more users using any of the machine learning based anomaly detection models or techniques discussed herein with respect to FIGS. 4, 5A, 5B, 6A, 6B, and 7.

Once one or more threshold levels of anomaly are detected in the user transaction data associated with the two or more users at operation 1209, process flow proceeds to operation 1211.

At operation 1211, the transaction data associated with the detected one or more threshold level of anomalies in the user transaction data is analyzed to determine a specific life event associated with each of the detected anomalies using any of the human-based methods discussed herein with respect to FIGS. 4, 5A, 5B, 6A, 6B, 7 and 8. Once a specific life event associated with each of the detected anomalies in the user transaction data is identified at operation 1211, identified specific life event data is the generated representing the identified specific life event for each of the detected anomalies.

Once a specific life event associated with each of the detected anomalies in the user transaction data is identified and identified specific life event data is generated representing the identified specific life event for each of the detected anomalies at operation 1211, process flow proceeds to operation 1213.

At operation 1213, machine learning model training data including anomalous transaction training data and identified specific life event data is generated using any of the methods discussed above with respect to FIG. 8.

Once machine learning model training data is generated at operation 1213, process flow proceeds to operation 1215.

At operation 1215, the machine learning model training data is used to train one or more machine learning-based life event identification models using any of the methods discussed above with respect to FIGS. 8 and 9.

Once the machine learning model training data is used to train one or more machine learning-based life event identification models at operation 1215, process flow proceeds to operation 1217.

At operation 1217, once the machine learning model training data is used to train one or more machine learning-based life event identification models, transaction data associated with a subsequent user of the data management system is received. The subsequent user transaction data can be any of the transaction data discussed herein with respect to FIG. 1 and FIG. 2, and can be obtained using any of the methods, and from any of the sources, discussed herein with respect to FIG. 1 and FIG. 2, or known in the art at the time of filing, or as become known after the time of filing.

Once transaction data associated with a subsequent user of the data management system is received at operation 1217, process flow proceeds to operation 1219.

At operation 1219, the user transaction data of operation 1217 is processed using any of the machine learning based anomaly detection models or techniques discussed herein with respect to FIGS. 4, 5A, 5B, 6A, 6B, and 7.

Once the user transaction data is processed using machine learning based anomaly detection models or techniques at operation 1219, process flow proceeds to operation 1221.

At operation 1221, a threshold level of anomaly is detected in the user transaction data associated with the user using any of the machine learning based anomaly detection techniques discussed herein with respect to FIGS. 4, 5A, 5B, 6A, 6B, and 7.

Once a threshold level of anomaly is detected in the user transaction data associated with the user at operation 1221, process flow proceeds to operation 1223.

At operation 1223 the transaction data associated with the detected threshold level of anomaly in the user transaction data is analyzed to identify a specific life event associated with the detected anomaly using the trained machine learning-based life event identification model of operation 1215, and the methods discussed herein with respect to FIGS. 4, 5A, 5B, 6A, 6B, 7 and 8.

Once the trained machine learning-based life event identification model is used to identify a specific life event associated with the detected anomaly in the user transaction data at operation 1223, process flow proceeds to operation 1225.

At operation 1225, one or more of the interactions between the user and the data management system are customized based on the identified specific life event associated with the detected anomaly in the user transaction data. The customizations can include any of the modifications/customizations discussed herein with respect to FIG. 1, or as known in the art at the time of filing, or as become known after the time of filing.

Once, one or more interactions between the user and the data management system are customized based, at least in part, on the identified specific life event associated with the detected anomaly, process flow proceeds to end operation 1230 and process 1200 is exited to await new data.

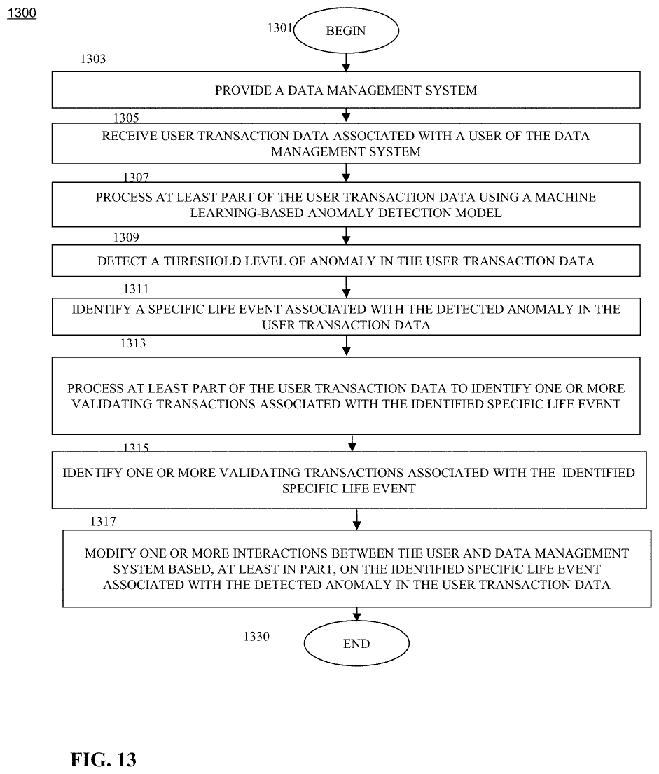

FIG. 13 is a flow chart representing a process for detecting life events by applying anomaly detection methods to transaction data including the identification and use of validation transactions in accordance with one embodiment.

As seen in FIG. 13, process 1300 begins at operation 1301 and process flow proceeds to operation 1303.

At operation 1303 a data management system such as any of the data management systems discussed herein with respect to FIG. 1 or known in the art at the time of filing, or as become known after the time of filing, is provided to one or more users.

Once a data management system is provided at operation 1303, process flow proceeds to operation 1305.

At operation 1305, user transaction data such as discussed herein with respect to FIG. 1 and FIG. 2, is obtained using any of the methods, and from any of the sources, discussed herein with respect to FIG. 1 and FIG. 2, or known in the art at the time of filing, or as become known after the time of filing.

Once user transaction data is received at operation 1305, process flow proceeds to operation 1307.

At operation 1307, the user transaction data of operation 1305 is processed using any of the machine learning based anomaly detection models or techniques discussed herein with respect to FIGS. 4, 5A, 5B, 6A, 6B, and 7.

Once the user transaction data is processed using machine learning based anomaly detection models or techniques at operation 1307, process flow proceeds to operation 1309.

At operation 1309, a threshold level of anomaly is detected in the user transaction data associated with the user using any of the machine learning based anomaly detection models or techniques discussed herein with respect to FIGS. 4, 5A, 5B, 6A, 6B, and 7.

Once a threshold level of anomaly is detected in the user transaction data associated with the user at operation 1309, process flow proceeds to operation 1311.

At operation 1311 the transaction data associated with the detected threshold level of anomaly in the user transaction data is analyzed to determine specific life event associated with the detected anomaly using any of the human or machine-based methods discussed herein with respect to FIGS. 4, 5A, 5B, 6A, 6B, 7 and 8.

Once a specific life event associated with the detected anomaly in the user transaction data is identified at operation 1311, process flow proceeds to operation 1313.

At operation 1313 the user transaction data associated with the user is searched to try and find validating transactions associated with the identified specific life event using any of the methods discussed above with respect to FIG. 10, or any methods known in the art at the time of filing, or any methods that become available after the time of filing.

Once the user transaction data associated with the user is searched to try and find validating transactions associated with the identified specific life event at operation 1313, process flow proceeds to operation 1315.

At operation 1315 one or more validating transactions are identified using any of the methods discussed above with respect to FIG. 10, or any methods known in the art at the time of filing, or any methods that become available after the time of filing. Data representing the identified one or more validating transactions associated with the identified specific life event is then analyzed to further confirm, or increase, the determined likelihood that the identified specific life event is the correct life event to be associated with the user.

Once one or more validating transactions are identified and data representing the identified one or more validating transactions is analyzed to further confirm, or increase, the determined likelihood that the predicted life event is the correct life event to be associated with the user at operation 1315, process flow proceeds to operation 1317.

At operation 1317, one or more of the interactions between the user and the data management system are customized based on the identified specific life event associated with the detected anomaly in the user transaction data. The customizations can include any of the modifications/customizations discussed herein with respect to FIG. 1, or as known in the art at the time of filing, or as become known after the time of filing.

Once, one or more of the interactions between the user and the data management system are customized based on the identified specific life event associated with the detected anomaly in the user transaction data at operation 1317, process flow proceeds to end operation 1330 and process 1300 is exited to await new data.

In accordance with a disclosed embodiment, a computing system implemented method includes receiving user transaction data associated with a user of a data management system. The user transaction data is then processed using a machine learning-based anomaly detection model to determine whether there are anomalies in the user transaction data.

In response to detecting an anomaly in the user transaction data, at least part of the user transaction data is further analyzed to identify a specific life event associated with the detected anomaly. One or more interactions between the user and the data management system are then modified based, at least in part, on the identified specific life event associated with the detected anomaly.

In accordance with a disclosed embodiment, a computing system implemented method includes receiving user transaction data associated with two or more users of a data management system. The user transaction data is then processed using a machine learning-based anomaly detection model to determine whether there are anomalies in the user transaction data. Then, for each detected anomaly in the user transaction data, at least part of the user transaction data is analyzed to identify a specific life event associated with the detected anomaly.

Machine learning model training data is then generated that includes anomalous transaction data associated with each detected anomaly correlated with identified specific life event data representing the identified specific life event associated with the detected anomaly. The machine learning model training data is then used to train a machine learning-based life event identification model to predict specific life events associated with detected anomalies in the transaction data.

User transaction data associated with a user of the data management system is then received. The user transaction data is then processed using a machine learning-based anomaly detection model to determine whether there are anomalies in the user transaction data.

In response to detecting an anomaly in the user transaction data, at least part of the user transaction data is analyzed by the machine learning-based life event identification model to identify a specific life event associated with the detected anomaly.

One or more interactions between the user and the data management system are then modified based, at least in part, on the identified specific life event associated with the detected anomaly.

In the discussion above, certain aspects of one embodiment include process steps and/or operations and/or instructions described herein for illustrative purposes in a specific order and/or grouping. However, the specific order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the specific order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
receiving, with the one or more computing systems, user transaction data associated with a user of a data management system;
processing the user transaction data using a machine learning-based anomaly detection model to determine whether there are anomalies in the user transaction data;
in response to detecting an anomaly in the user transaction data, analyzing at least part of the user transaction data to identify a specific life event associated with the detected anomaly; and
modifying one or more interactions between the user and the data management system based, at least in part, on the identified specific life event associated with the detected anomaly.

2. The computing system implemented method of claim 1 wherein the user transaction data is updated as new user transactions are received.

3. The computing system implemented method of claim 1 wherein the machine learning-based anomaly detection model is an unsupervised machine learning-based anomaly detection model.

4. The computing system implemented method of claim 1 wherein processing the user transaction data using a machine learning-based anomaly detection model includes:
generating base/v1 vector data using user transaction data representing user transactions in a base window of user transactions;
generating comparison/v2 vector data using user transaction data representing user transactions in a comparison window of user transactions; and
detecting an anomaly in the user transaction data by identifying a threshold level of difference between the base/v1 vector data and the comparison/v2 vector data.

5. The computing system implemented method of claim 4 wherein the base window of user transactions and comparison window of user transactions are a single sliding window of user transactions that adjusts as new transactions are received.

6. The computing system implemented method of claim 1 wherein analyzing at least part of the user transaction data to identify a specific life event associated with the detected anomaly is performed using a machine learning-based life event identification model.

7. The computing system implemented method of claim 6 wherein the machine learning-based life event identification model is a classifier model trained using training data that includes input objects representing anomalous transaction data associated with the detected anomalies and supervisory signals representing the identified specific life events associated with the respective detected anomalies.

8. The computing system implemented method of claim 1 wherein modifying one or more interactions between the user and the data management system includes customizing a user interface screen provided to the user by the data management system based, at least in part, on the identified specific life event associated with the detected anomaly in the user transaction data.

9. The computing system implemented method of claim 1 wherein modifying one or more interactions between the user and the data management system includes customizing a series of questions provided to the user by the data management system based, at least in part, on the identified specific life event associated with the detected anomaly in the user transaction data.

10. The computing system implemented method of claim 1 wherein modifying one or more interactions between the user and the data management system includes customizing one or more offers provided to the user through the data management systems based, at least in part, on the identified specific life event associated with the detected anomaly in the user transaction data.

11. A computing system implemented method comprising:
receiving, with the one or more computing systems, user transaction data associated with two or more users of a data management system;
processing the user transaction data using a machine learning-based anomaly detection model to determine whether there are anomalies in the user transaction data;
for each detected anomaly in the user transaction data, analyzing at least part of the user transaction data to identify a specific life event associated with the detected anomaly; and
generating machine learning model training data that includes anomalous transaction data associated with each detected anomaly correlated with identified specific life event data representing the identified specific life event associated with the detected anomaly;
using the machine learning model training data to train a machine learning-based life event identification model to predict specific life events associated with detected anomalies in the transaction data.

12. The computing system implemented method of claim 11 further comprising:
receiving, with the one or more computing systems, user transaction data associated with a user of the data management system;
processing the user transaction data using a machine learning-based anomaly detection model to determine whether there are anomalies in the user transaction data;
in response to detecting an anomaly in the user transaction data, using the trained machine learning-based life event identification model to predict a specific life event associated with the detected anomaly in the user transaction data; and
modifying one or more interactions between the user and the data management system based, at least in part, on the specific life event predicted to be associated with the detected anomaly in the user transaction data.

13. The computing system implemented method of claim 12 wherein the anomaly detection model is an unsupervised machine learning-based anomaly detection model.

14. The computing system implemented method of claim 12 wherein processing the user transaction data using a machine learning-based anomaly detection model includes:
generating base/v1 vector data using user transaction data representing user transactions in a base window of user transactions;
generating comparison/v2 vector data using user transaction data representing user transactions in a comparison window of user transactions; and
detecting an anomaly in the user transaction data by identifying a threshold level of difference between the base/v1 vector data and the comparison/v2 vector data.

15. The computing system implemented method of claim 11 wherein the machine learning-based life event identification model is a supervised machine learning classification model.

16. A computing system implemented method comprising:
receiving, with the one or more computing systems, user transaction data associated with a user of a data management system;
processing the user transaction data using a machine learning-based anomaly detection model to determine whether there are anomalies in the user transaction data;
in response to detecting an anomaly in the user transaction data, analyzing at least part of the user transaction data to identify a specific life event associated with the detected anomaly;
further processing the user transaction data to identify one or more validating transactions in the user transaction data related to the identified specific life event;
identifying one or more validating transactions associated with the identified specific life event in the user transaction data; and
modifying one or more interactions between the user and the data management system based, at least in part, on the identified specific life event associated with the detected anomaly in the user transaction data.

17. The computing system implemented method of claim 16 wherein the user transaction data is updated as new user transactions are received.

18. The computing system implemented method of claim 16 wherein the anomaly detection model is an unsupervised machine learning-based anomaly detection model.

19. The computing system implemented method of claim 16 wherein processing the user transaction data using a machine learning-based anomaly detection model includes:
generating base/v1 vector data using user transaction data representing user transactions in a base window of user transactions;
generating comparison/v2 vector data using user transaction data representing user transactions in a comparison window of user transactions; and
detecting an anomaly in the user transaction data by identifying a threshold level of difference between the base/v1 vector data and the comparison/v2 vector data.

20. The computing system implemented method of claim 19 wherein the base window of user transactions and comparison window of user transactions are a single sliding window of user transactions that adjusts as new transactions are received.
